(19) United States
(12) Patent Application Publication
(10) Pub. No.: US 2011/0285625 A1
(43) Pub. Date: Nov. 24, 2011

(54) INFORMATION PROCESSING APPARATUS AND INPUT METHOD

(75) Inventor: Wataru NAKANISHI, Ome-shi (JP)

(73) Assignee: KABUSHIKI KAISHA TOSHIBA, Tokyo (JP)

(21) Appl. No.: 13/097,487

(22) Filed: Apr. 29, 2011

(30) Foreign Application Priority Data
May 21, 2010 (JP) 2010-117600

(51) Int. Cl. G06F 3/041

(52) U.S. Cl. 345/158

(57) ABSTRACT

According to one embodiment, an information processing apparatus comprises a touch-screen display, a detection module and an output module. The detection module is configured to detect a number of touch positions on the touch-screen display. The output module is configured to output first data indicative of a touch position on the touch-screen display in order to activate a function associated with a touched display object on the touch-screen display, the output module being configured to output second data indicative of a direction of movement and an amount of movement of a touch position on the touch-screen display, in place of the first data, in order to move a cursor on a screen of a display, if the detection module detects that a plurality of positions on the touch-screen display are touched.

### CROSS-REFERENCE TO RELATED APPLICATIONS

This application is based upon and claims the benefit of priority from Japanese Patent Application No. 2010-117600, filed May 21, 2010; the entire contents of which are incorporated herein by reference.

### FIELD

Embodiments described herein relate generally to an information processing apparatus comprising a touch-screen display, and an input method for use in the apparatus.

### BACKGROUND

In recent years, various types of information processing apparatuses, such as PDAs, have been developed. Most of the information processing apparatuses use pointing devices such as touchpads. The user can move the position of a cursor on the screen, for example, by tracing the touchpad by a finger.

In addition, recently, portable personal computers and PDAs, which include touch-screen displays, such as touch panels, have been developed. For example, by touching a display object (e.g. a button, an icon, etc.) on the touch-screen display by a fingertip or pen, the user can activate a function which is associated with the display object.

Further, in this technical field, a touch detection area is used as a keyboard. As a method for using the touch detection area as the keyboard, there is, for example, a method of using a keyboard sheet which is attached on the touch detection area. When one of a plurality of character keys on the keyboard sheet has been touched by a pen, a character corresponding to the touched character key is input.

In the meantime, in the conventional information processing apparatus with the touch-screen display, the touch-screen display is, in usual cases, used in order to make the user designate any one of display objects on the screen of the touch-screen display. Thus, in the conventional information processing apparatus, in order to move the cursor on the screen, a pointing device (relative pointing device) such as a touchpad needs to be provided in addition to the touch-screen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment.

FIG. 2 is an exemplary view illustrating an example of a virtual keyboard which is displayed on a touch-screen display of the information processing apparatus of the embodiment.

FIG. 3 is an exemplary view for describing a touch-panel mode and a touchpad mode of the information processing apparatus of the embodiment.

FIG. 4 is an exemplary view for describing an operation which is executed while the information processing apparatus of the embodiment is in the touchpad mode.

FIG. 5 is an exemplary view for describing a multi-touch-position detection operation which is executed by the information processing apparatus of the embodiment.

FIG. 6 is an exemplary block diagram illustrating the system configuration of the information processing apparatus of the embodiment.

FIG. 7 is an exemplary block diagram illustrating the structure of an input control program which is used in the information processing apparatus of the embodiment.

FIG. 8 is an exemplary flow chart illustrating the procedure of an input process which is executed by the information processing apparatus of the embodiment.

### DETAILED DESCRIPTION

Various embodiments will be described hereinafter with reference to the accompanying drawings.

In general, according to one embodiment, an information processing apparatus comprises a touch-screen display, a detection module and an output module. The detection module is configured to detect a number of touch positions on the touch-screen display. The output module is configured to output first data indicative of a touch position on the touch-screen display in order to activate a function associated with a touched display object on the touch-screen display, the output module being configured to output second data indicative of a direction of movement and an amount of movement of a touch position on the touch-screen display, in place of the first data, in order to move a cursor on a screen of a display, if the detection module detects that a plurality of positions on the touch-screen display are touched.

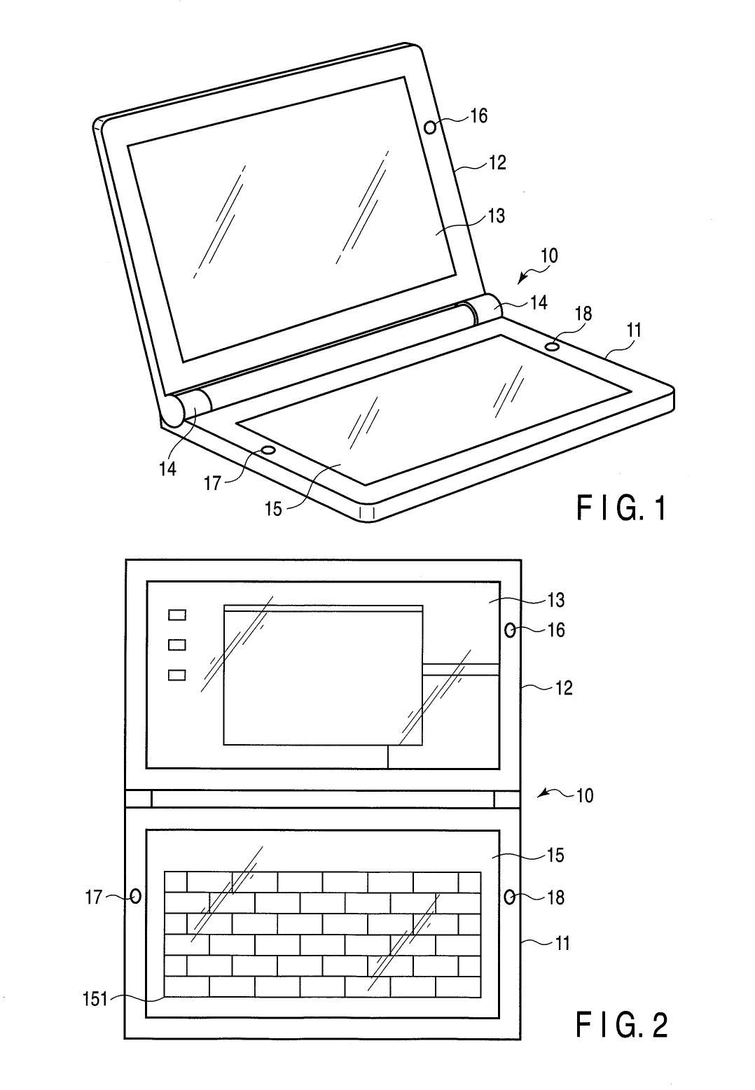

To begin with, referring to FIG. 1, an information processing apparatus according to an embodiment is described. This information processing apparatus is realized, for example, as a battery-powerable portable personal computer 10.

FIG. 1 is a perspective view showing the personal computer 10 in a state in which a display unit of the personal computer 10 is opened. The computer 10 comprises a computer main body 11 and a display unit 12. A display device comprising a liquid crystal display (LCD) 13 is built in a top surface of the display unit 12, and a display screen of the LCD 13 is disposed at a substantially central part of the display unit 12.

The display unit 12 has a thin box-shaped housing. The display unit 12 is rotatably attached to the computer main body 11 via a hinge portion 14. The hinge portion 14 is a coupling portion for coupling the display unit 12 to the computer main body 11. Specifically, a lower end portion of the display unit 12 is supported on a rear end portion of the computer main body 11 by the hinge portion 14. The display unit 12 is attached to the computer main body 11 such that the display unit 12 is rotatable, relative to the computer main body 11, between an open position where the top surface of the computer main body 11 is exposed and a closed position where the top surface of the computer main body 11 is covered by the display unit 12. A power button 16 for powering on or off the computer 10 is provided at a predetermined position on the top surface of the display unit 12, for example, on the right side of the LCD 13.

The computer main body 11 is a base unit having a thin box-shaped housing. A liquid crystal display (LCD) 15, which functions as a touch-screen display, is built in a top surface of the computer main body 11. A display screen of the LCD 15 is disposed at a substantially central part of the computer main body 11. A transparent touch panel is disposed on the top surface of the LCD 15, and the touch-screen display is realized by the LCD 15 and the transparent touch panel. The touch-screen display is capable of detecting a touch position on the display screen which is touched by a pen or a finger. The LCD 15 on the computer main body 11 is a display which is independent from the LCD 13 of the display unit 12. The LCDs 13 and 15 can be used as a multi-display for realizing a virtual screen environment. In this case, the virtual screen, which is managed by the operating system of the computer 10, comprises a first screen region which is displayed on the LCD 13, and a second screen region which is displayed on the LCD 15. An arbitrary application window, an arbitrary object, etc. can be displayed on the first screen region and the second screen region.

In the present embodiment, the LCD 15 (touch-screen display) provided on the top surface of the main body 11 may be used to present, for example, a virtual keyboard (also referred to as “software keyboard”), as shown in FIG. 2. The virtual keyboard 151 may be displayed, for example, on the entirety of the display screen of the LCD 15 in a full-screen mode. The virtual keyboard 151 comprises a plurality of virtual keys (e.g. a plurality of numeral keys, a plurality of alphabet keys, a plurality of arrow keys, a plurality of auxiliary keys, and a plurality of function keys) for inputting a plurality of key codes (code data). To be more specific, the virtual keyboard 151 comprises a plurality of buttons (software buttons) corresponding to the respective virtual keys.

On the other hand, the LCD 13 in the display unit 12 can be used as a main display for displaying various application windows, etc., as shown in FIG. 2. The user can input various code data (key code, character code, command, etc.) on the application window, etc. displayed on the LCD 13, by performing a touch operation on the virtual keyboard 151 displayed on the touch-screen display 15. The LCD 13 may also be realized as a touch-screen display.

Two button switches 17 and 18 are provided at predetermined positions on the top surface of the computer main body 11, for example, on both sides of the LCD 15. Arbitrary functions can be assigned to the button switches 17 and 18. For example, the button switch 17 may be used as a button switch for starting a key input program which is an application program for controlling a key input operation using the virtual keyboard 151. When the button switch 17 has been pressed by the user, the key input program is started. The key input program displays the virtual keyboard 151 on the touch-screen display 15.

In the present embodiment, the LCD 15 (touch-screen display) provided on the top surface of the main body 11 can also be used as a touchpad which is a relative pointing device for moving a cursor on the screen of the LCD 13. For example, an input control program for inputting data by using the touch-screen display is pre-installed in the computer 10 of the embodiment. The input control program can emulate the operation of a touchpad by using a touch position detection function of the touch-screen display (touch panel). The input control program has two operation modes, namely a touch panel mode and a touchpad mode, and operates in one of the two operation modes. In the touch panel mode, in order to activate a function which is associated with a touched display object (button, icon, virtual key, etc.) on the touch-screen display, the input control program outputs data indicative of the touch position on the touch-screen display to the operating system or application program. The touch position is represented by, e.g. absolute coordinates. In the touchpad mode, in order to move the cursor on the screen of the display (LCD 13 or LCD 15), the input control program calculates a relative coordinate value for designating a target position of the cursor, i.e. the direction of movement and the amount of movement of the touch position, in accordance with the movement of the touch position on the touch-screen display, and outputs the calculated data to the operating system or application program. In this manner, in the touchpad mode, the data indicative of the direction of movement and the amount of movement of the touch position is output in place of the data indicative of the touch position on the touch-screen display.

In addition, in order to seamlessly switch the operation mode between the touch panel mode and touchpad mode, the input control program comprises a function of detecting, for example, the number of touch positions on the touch-screen display. In this case, the operation mode of the input control program may automatically be switched from the touch panel mode to the touchpad mode, on condition that a plurality of positions on the touch-screen display have been touched. Besides, the operation mode of the input control program may automatically be switched from the touch panel mode to the touchpad mode, on condition that a plurality of positions, which neighbor each other on the touch-screen display, have been touched. There is a case in which the user touches two display objects such as two virtual keys on the virtual keyboard 151 at the same time. Thus, the method in which the operation mode of the input control program is switched to the touchpad mode, on condition that a plurality of positions, which neighbor each other on the touch-screen display, have been touched, can decrease the possibility that the operation mode is erroneously switched to the touchpad mode.

While the user is performing a touch operation on the touch-screen display by one finger, the input control program operates in the touch panel mode. When the user has touched two neighboring positions on the touch-screen display by two fingers, the operation mode of the input control program is switched from the touch panel mode to the touchpad mode.

Besides, the input control program may be configured to operate in the touchpad mode while a plurality of neighboring touch positions are being moved as in the case where the user traces the touch-screen display by two fingers, and to operate in the touch panel mode at other times.

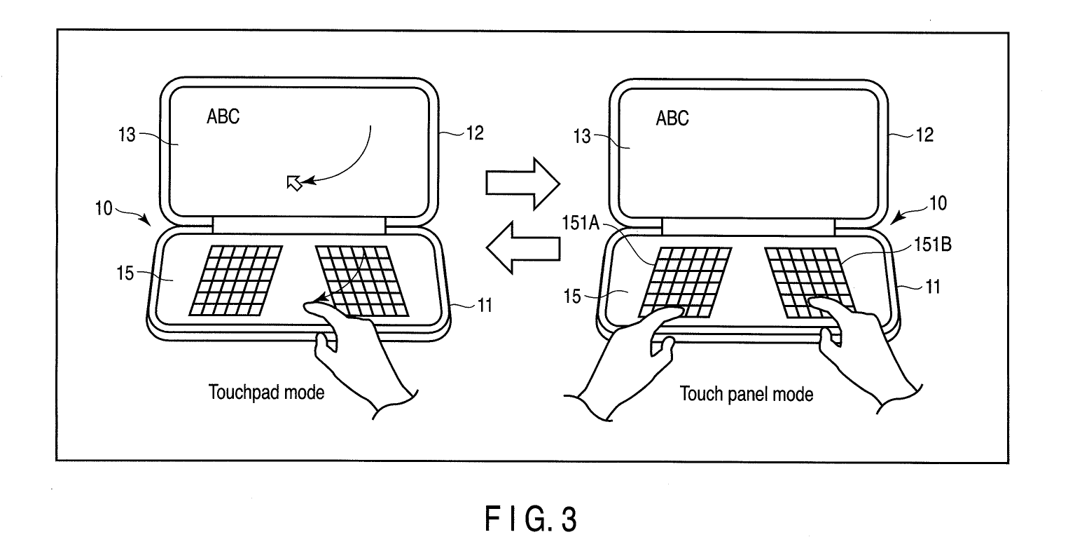

FIG. 3 illustrates examples of the modes of use in the touchpad mode and the touch panel mode. A left part of FIG. 3 illustrates an example of the mode of use in the touchpad mode. The input control program detects a movement of a touch position on the LCD 15 (touch-screen display) and outputs, based on the detection result, a relative coordinate value for designating a target position of the cursor, i.e. the data indicative of the direction of movement and the amount of movement of the touch position, to the operating system or application program. Accordingly, in the touchpad mode, the user can move, for example, the cursor (mouse cursor) on the screen of the LCD 13, by tracing the LCD 15 (touch-screen display) by the finger. In the meantime, the cursor may be displayed on the LCD 15 (touch-screen display). Besides, the cursor may be moved to any position on the virtual screen including the LCD 13 and LCD 15.

A right part of FIG. 3 illustrates an example of the mode of use in the touch panel mode. The case is assumed in which a touch operation is performed on virtual keyboards 151A and 151B which are displayed on the LCD 15 (touch-screen display). The virtual keyboard 151A is a part of the above-described virtual keyboard, and the virtual keyboard 151B is the other part of the above-described virtual keyboard. The input control program outputs an absolute coordinate value indicative of a position (touch position) on the LCD 15 (touch-screen display), which has been touched by the user, to the key input program. The key input program selects, from among the plural virtual keys, a virtual key located at the touch position indicated by the absolute coordinates, and outputs a key code associated with the selected virtual key. Thereby, a character string “ABC”, for instance, is displayed on the screen of the LCD 13.

In the meantime, the operation mode of the input control program may be changed from the touch panel mode to the touchpad mode, without changing the screen image on the LCD 15 (touch-screen display) in the touch panel mode.

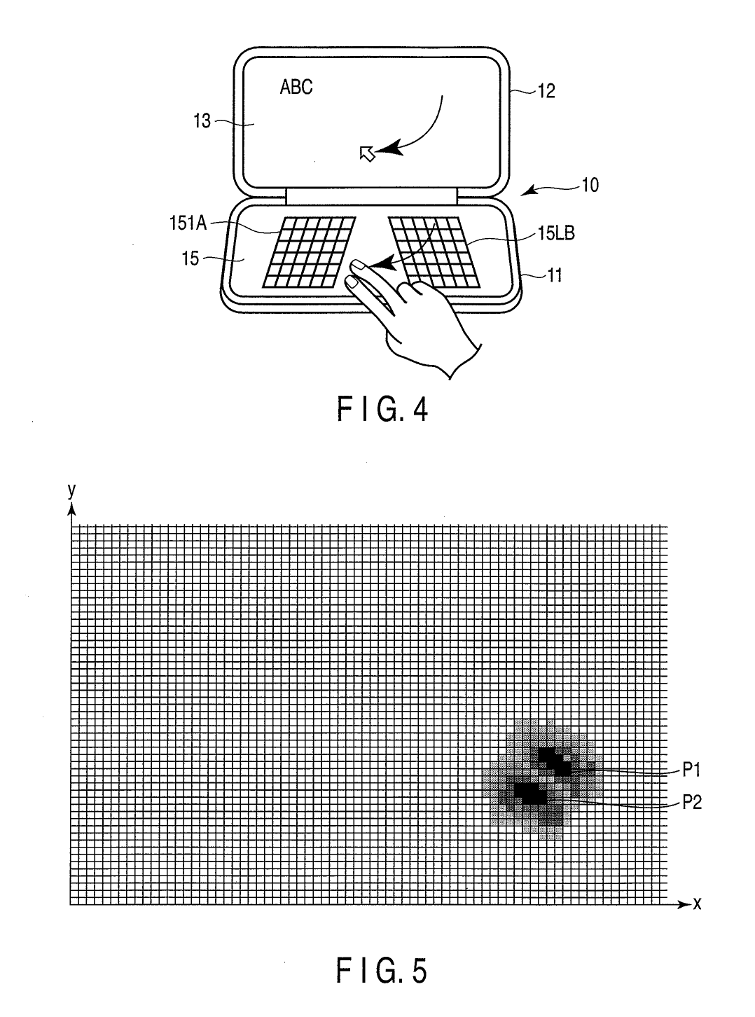

FIG. 4 illustrates an example of an operation which is executed when the user traces the screen of the LCD 15 (touch-screen display) by two fingers during the period in which the user inputs characters by using the virtual keyboards 151A and 151B. When the screen of the LCD 15 (touch-screen display) has been touched by the two fingers, the input control program transitions to the touchpad mode while maintaining the current screen image. In place of the absolute coordinate value indicative of the touch position, the input control program outputs the data indicative of the direction of movement and the amount of movement of the touch positions in accordance with the movement of the two fingers on the screen of the LCD 15 (touch-screen display). In this case, even if any one of the fingertips is placed on a display object (a virtual key in this case) of the LCD 15 (touch-screen display), the function associated with this display object is not executed.

When the touch state of the touch-screen display has been released, that is, when the two fingers have been separated from the screen of the LCD 15 (touch-screen display), the operation mode of the input control program returns from the touchpad mode to the touch panel mode. The user can input characters by performing a touch operation on the virtual keyboard 151A, 151B.

As described above, only when a plurality of positions on the touch-screen display have been touched and these touch positions have been moved, may the input control program may operate in the touchpad mode. As a result, without the user performing a purpose-specific operation for mode switching, the touch panel mode and the touchpad mode can seamlessly be switched. As described above, the operation mode of the input control program may be switched to the touchpad mode, only on condition that a plurality of positions on the touch-screen display have been touched. In this case, after the operation mode of the input control program has been switched to the touchpad mode, the user can move the position of the cursor, for example, by tracing the screen of the touch-screen display by one finger.

Next, referring to FIG. 5, an operation for detecting a plurality of touch positions is described. FIG. 5 shows the relationship between a touch position and a touch intensity on the touch-screen display. The abscissa (x-axis) in FIG. 5 indicates the position in the horizontal direction on the touch-screen display, and the ordinate (y-axis) in FIG. 5 indicates the position in the vertical direction on the touch-screen display. In FIG. 5, a black part represents a part which is touched with a high intensity, a deep-gray part represents a part which is touched with an intermediate intensity, and a light-gray part represents a part which is touched with a low intensity. When the screen of the touch-screen display is touched by two fingers, peaks of touch intensity appear at two locations P1 and P2 (black parts). The input control program detects the two locations P1 and P2 as touch positions.

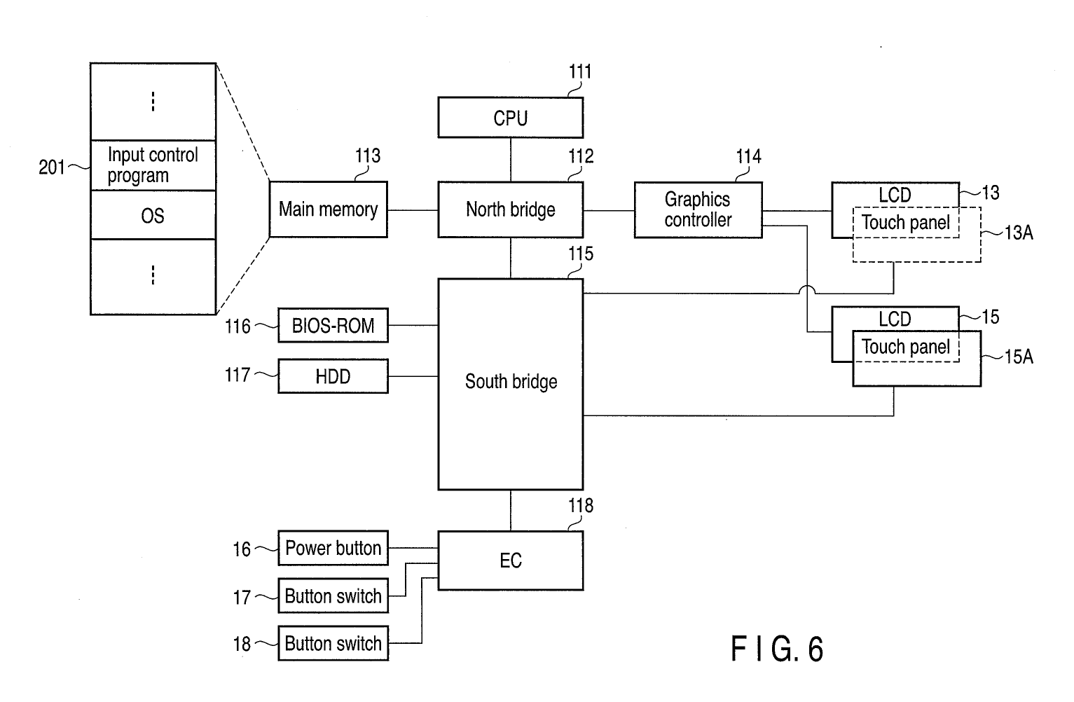

Next, referring to FIG. 6, the system configuration of the computer 10 is described. The case is now assumed in which both LCDs 13 and 15 are realized as touch-screen displays.

The computer 10 comprises a CPU 111, a north bridge 112, a main memory 113, a graphics controller 114, a south bridge 115, a BIOS-ROM 116, a hard disk drive (HDD) 117, and an embedded controller 118.

The CPU 111 is a processor which is provided in order to control the operation of the computer 10. The CPU 111 executes an operating system (OS) and various application programs, which are loaded from the HDD 117 into the main memory 113. The application programs include an input control program 201. The input control program 201, as described above, emulates the operation of the touchpad by using a touch position detection function of the touch-screen display (touch panel). Besides, the CPU 111 executes a system BIOS (Basic Input/Output System) which is stored in the BIOS-ROM 116. The system BIOS is a program for hardware control.

The north bridge 112 is a bridge device which connects a local bus of the CPU 111 and the south bridge 115. The north bridge 112 includes a memory controller which access-controls the main memory 113. The graphics controller 114 is a display controller which controls the two LCDs 13 and 15 which are used as a display monitor of the computer 10. The graphics controller 114 executes a display process (graphics arithmetic process) for rendering display data on a video memory (VRAM), based on a rendering request which is received from the CPU 111 via the north bridge 112. A memory area for storing display data corresponding to a screen image which is displayed on the LCD 13 and a memory area for storing display data corresponding to a screen image which is displayed on the LCD 15 are allocated to the video memory. A transparent touch panel 13A is disposed on the LCD 13. Similarly, a transparent touch panel 15A is disposed on the LCD 15. Each of the touch panels 13A and 15A is configured to detect a touch position on the touch panel (touch-screen display) by using, for example, a resistive method or a capacitive method. As each of the touch panel 13A, 15A, use may be made of a multi-touch panel which can detect a plurality of touch positions at the same time.

The south bridge 115 incorporates an IDE (Integrated Drive Electronics) controller and a Serial ATA controller for controlling the HDD 121. The embedded controller (EC) 118 has a function of powering on/off the computer 10 in accordance with the operation of the power button switch 16 by the user.

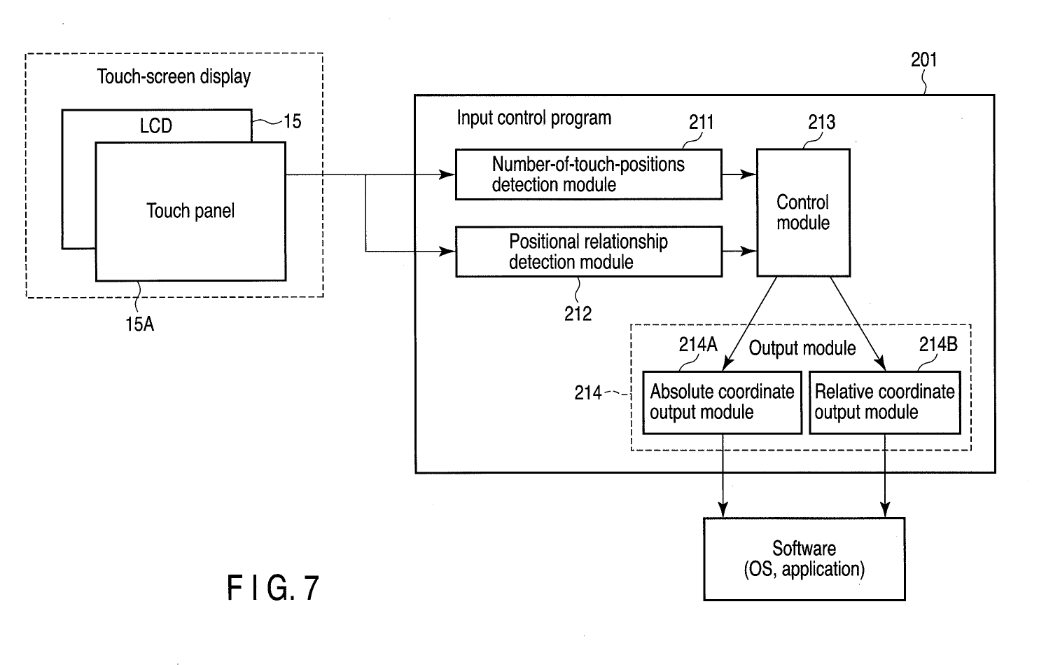

Next, referring to FIG. 7, the functional structure of the input control program 201 is described.

The input control program 201 comprises a number-of-touch-positions detection module 211, a positional relationship detection module 212, a control module 213, and an output module 214. The number-of-touch-positions detection module 211 detects the number of touch positions on the touch-screen display. The positional relationship detection module 212 detects, when the number-of-touch-positions detection module 211 has detected that a plurality of positions on the touch-screen display have been touched, the positional relationship between the touch positions, and determines whether the touch positions neighbor each other or not. The control module 213 controls the operation of the output module 214, based on the detection results of the number-of-touch-positions detection module 211 and positional relationship detection module 212.

The output module 214 outputs data (absolute coordinate value) indicative of a touch position on the touch-screen display, thereby to activate the function which is associated with a touched display object on the touch-screen display. Further, the output module 214 transitions to a touchpad mode when a transition to the touchpad mode has been instructed by the control module 213, or in other words, for example, a plurality of neighboring positions on the touch-screen display have been touched. In the touchpad mode, in order to move the cursor on the screen of the display, the output module 214 outputs data indicative of the direction of movement and the amount of movement of the touch position, in place of the data indicative of the touch position on the touch-screen display.

The output module 214 comprises an absolute coordinate output module 214A and a relative coordinate output module 215B. The absolute coordinate output module 214A is configured to operate in a touch panel mode, and outputs data (absolute coordinate value) indicative of the touch position on the touch-screen display to the operating system or application program. On the other hand, the relative coordinate output module 215B is configured to operate in a touchpad mode, and outputs the data indicative of the direction of movement and the amount of movement of the touch position on the touch-screen display to the operating system or application program.

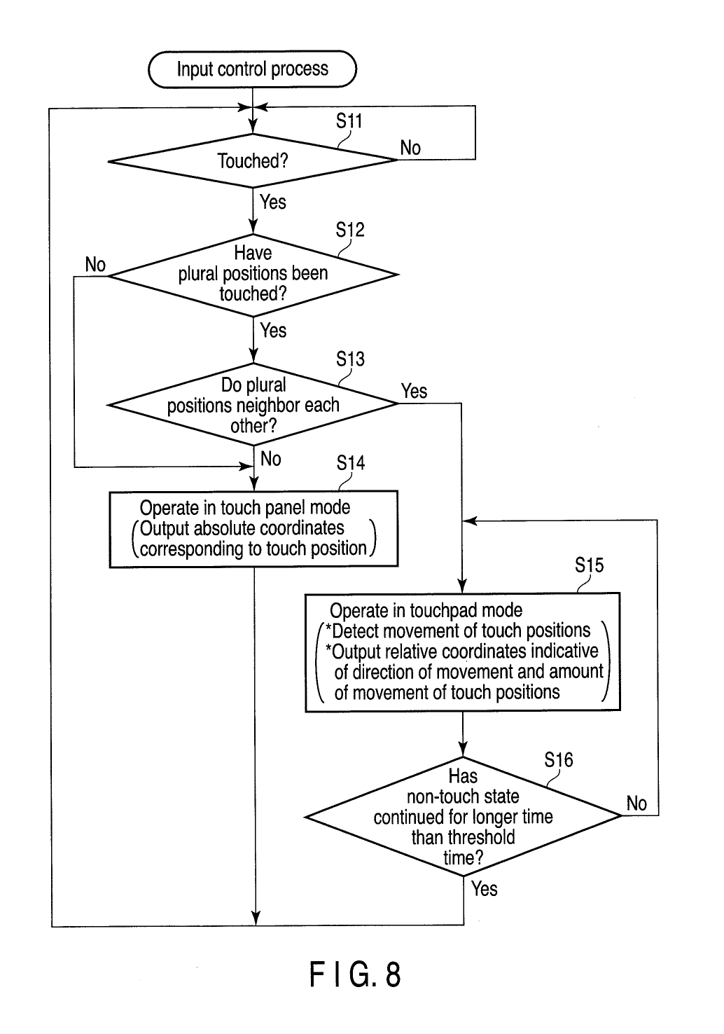

Next, referring to a flow chart of FIG. 8, a description is given of the procedure of an input process which is executed by the input control program 201.

The input control program 201 receives touch position detection information from the touch panel 15A, and determines, based on the touch position detection information, whether the screen of the touch-screen display has been touched. If the screen of the touch-screen display has been touched (YES in step S11), the input control program 201 determines whether a plurality of positions (e.g. two positions) on the screen of the touch-screen display have been touched (step S12). If a plurality of positions on the screen of the touch-screen display have been touched (YES in step S12), the input control program 201 determines whether the plural touch positions neighbor each other, for example, whether the distance between two touch positions is less than a threshold distance (step S13).

If a plurality of positions have not been touched (NO in step S12) or if the plural touch positions do not neighbor each other (NO in step S13), the input control program 201 operates in the touch panel mode and outputs the absolute coordinates corresponding to the touch position (first data indicative of the touch position) to the operating system or application program.

If the plural touch positions neighbor each other (YES in step S13), the input control program 201 starts to operate in the touchpad mode (step S15). In addition, the input control program 201 detects the movement of the touch position on the screen of the touch-screen display and outputs, in accordance with the detection result, second data (relative coordinate value) indicative of the direction of movement and the amount of movement of the touch position, in place of the above-described first data, to the operating system or application program (step S15).

If a non-touch state of the touch-screen display continues for a longer time than a threshold time (YES in step S16), the input control program 201 once exits from the touchpad mode. The input control program 201 returns to step S11.

As has been described above, according to the present embodiment, data indicative of a touch position on the touch-screen display is normally output. However, if it is detected than a plurality of positions on the touch-screen display have been touched, the second data indicative of the direction of movement and the amount of movement of the touch position on the touch-screen display are output, in place of the first data indicative of the touch position on the touch-screen display, thereby to move the cursor on the screen of the display. Thus, without providing a dedicated touchpad, the cursor can easily be moved by using the touch-screen display. In addition, since the user can use the touch-screen display as a touchpad by simply touching the touch-screen display by, e.g. a plurality of fingers, the user can perform seamless switching between the touch-panel mode and the touchpad mode, without performing a purpose-specific operation for mode switching.

The computer 10 of the embodiment includes the main body 11 and the display unit 12. It is not necessary to provide almost all the components, which constitute the system of the computer 10, within the main body 11. For example, some or almost all these components may be provided within the display unit 12. In this sense, it can be said that the main body 11 and the display unit 11 are substantially equivalent units. Therefore, the main body 11 can be thought to be the display unit, and the display unit 12 can be thought to be the main body.

The computer 10 of the embodiment includes the display (LCD 13) in addition to the touch-screen display. Alternatively, the computer 10 may be configured to include only the touch-screen display, without including the display (LCD 13).

Besides, the key input function of the embodiment is realized by a computer program. Thus, the same advantageous effects as with the present embodiment can easily be obtained simply by installing the computer program into a computer including a touch-screen display through a computer-readable storage medium which stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a touch-screen display;
a detection module configured to detect one or more contact positions on the touch-screen display and to determine the number of contact positions; and
a processor configured to output first data indicative of a first contact position on the touch-screen display in order to activate a function associated with a touched display object on the touch-screen display, the processor being configured to output second data indicative of a direction of movement and an amount of movement of the first contact position on the touch-screen display, in place of the first data, in order to move a cursor on a screen of a display, if the number of contact positions is equal to or larger than two.

2. The information processing apparatus of claim 1, wherein the processor is configured to output the second data in place of the first data, if the number of the contact positions is equal to or larger than two and the contact positions are substantially close to each other.

3. The information processing apparatus of claim 1, wherein the first data is an absolute coordinate value indicative of the first contact position on the touch-screen display.

4. The information processing apparatus of claim 1, wherein the second data is a relative coordinate value of a target destination position of the movement of the cursor.

5. An input method of inputting data with use of a touch-screen display of an information processing apparatus, the method comprising:
detecting one or more contact positions on the touch-screen display;
determining the number of the contact positions;
outputting first data indicative of a first contact position on the touch-screen display in order to activate a function associated with a touched display object on the touch-screen display; and
outputting second data indicative of a direction of movement and an amount of movement of a first contact position on the touch-screen display, in place of the first data, in order to move a cursor on a screen of a display, if the number of the contact positions is equal to or larger than two.

6. The input method of claim 5, wherein the outputting the second data comprises outputting the second data in place of the first data, if the number of the contact positions is equal to or larger than two and the contact positions are substantially close to each other.

7. The input method of claim 6, wherein the first data is an absolute coordinate value indicative of the first contact position on the touch-screen display.

8. The input method of claim 6, wherein the second data is a relative coordinate value of a target destination position of the movement of the cursor.

9. A non-transitory computer readable medium having stored thereon a program for inputting data with use of a touch-screen display of a computer, the program being configured to cause the computer to:
detect one or more contact positions on the touch-screen display;
determine the number of the contact positions;
output first data indicative of a first contact position on the touch-screen display in order to activate a function associated with a touched display object on the touch-screen display; and
output second data indicative of a direction of movement and an amount of movement of a first contact position on the touch-screen display, in place of the first data, in order to move a cursor on a screen of a display, if the number of the contact positions is equal to or larger than two.

10. The non-transitory computer readable medium of claim 9, wherein the second data is output in place of the first data, if the number of the contact positions is equal to or larger than two and the contact positions are substantially close to each other.

11. The non-transitory computer readable medium of claim 9, wherein the first data is an absolute coordinate value indicative of the first contact position on the touch-screen display.

12. The non-transitory computer readable medium of claim 9, wherein the second data is a relative coordinate value of a target destination position of the movement of the cursor.
